(19) United States
(12) Patent Application Publication
(10) Pub. No.: US 2014/0095728 A1
(43) Pub. Date: Apr. 3, 2014

(54) Methods and Systems for Providing Multiple Network Services By Way of a Single Machine-to-Machine Gateway Device

(71) Applicants: VERIZON PATENT AND LICENSING INC., Arlington, VA (US); CELLCO PARTNERSHIP D/B/A VERIZON WIRELES, Basking Ridge, NJ (US)

(72) Inventors: Lily Zhu, Parsippany, NJ (US); Aparna Khurjekar, Basking Ridge, NJ (US); Theresa Wong, New York, NY (US)

(73) Assignees: CELLCO PARTNERSHIP D/B/A VERIZON WIRELESS, Basking Ridge, NJ (US); VERIZON PATENT AND LICENSING INC., Arlington, VA (US)

(21) Appl. No.: 13/631,299

(22) Filed: Sep. 28, 2012

(51) Int. Cl. G06F 15/16

(52) U.S. Cl. 709/231

(57) ABSTRACT

An exemplary method includes a machine-to-machine (“M2M”) solutions provider subsystem 1) maintaining data representative of a plurality of distinct data processing schemes associated with a plurality of network services, 2) receiving a plurality of data streams from a single M2M gateway device, 3) identifying a data stream included in the plurality of data streams as corresponding to a network service included in the plurality of network services, and 4) processing, in response to the identifying, the data stream in accordance with a data processing scheme associated with the network service and included in the plurality of distinct data processing schemes. Corresponding methods and systems are also disclosed.

### BACKGROUND INFORMATION

Machine-to-machine (“M2M”) technology is a growing industry designed to communicatively connect machines to one another. An M2M solutions provider uses M2M technology to provide an M2M solution to a customer. For example, an M2M solutions provider may provide a customer such as a trucking company with an M2M solution that communicatively connects the trucking company's fleet of trucks to a company computing system (e.g., a personal or server computer operated by the trucking company). Company personnel may utilize the company computing system to monitor and/or control the fleet of trucks by way of the M2M solution.

To facilitate M2M communication, an M2M device (i.e., a device that includes a cellular modem capable of communicating by way of an M2M platform) may be installed within an automobile, home, or other premises that has equipment and/or devices that are to be monitored utilizing M2M technology. For example, a wireless enabled telematics control unit (“TCU”) may be installed within an automobile and used to wirelessly provide safety, security and diagnostics (“SSD”) data associated with the automobile to a SSD company (e.g., OnStar). As another example, a wireless enabled utility meter may be installed within a home and used to wirelessly transmit power consumption data associated with the home to a utility company.

A conventional M2M device transmits and receives M2M data by way of a wireless connection associated with a single subscription plan paid for by a single entity (e.g., a customer of an M2M solutions provider). Hence, only a single network service paid for by a single entity may be provided by way of a conventional M2M device. For example, a wireless enabled TCU that has been installed within an automobile and that has been configured to be used to provide an SSD service may not be concurrently used to provide another type of network service (e.g., a non-M2M network service such as a mobile broadband service). Unfortunately, this does not take advantage of the relatively high bandwidth wireless connections (e.g., Long Term Evolution (“LTE”) connections) which could simultaneously support multiple network services and that are now available to many M2M devices.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary M2M system according to principles described herein.

FIG. 2 illustrates an exemplary implementation of the M2M system of FIG. 1 according to principles described herein.

FIG. 3 illustrates various components of an M2M solutions provider subsystem according to principles described herein.

FIG. 4 shows an exemplary configuration in which a plurality of data streams are received by an M2M solutions provider subsystem according to principles described herein.

FIG. 5 illustrates various components of an M2M gateway device according to principles described herein.

FIG. 6 shows an exemplary implementation of the M2M system of FIG. 1 according to principles described herein.

FIG. 7 shows an exemplary implementation of the M2M system of FIG. 1 according to principles described herein.

FIG. 8 shows an exemplary look up table that may be maintained by an M2M solutions provider subsystem according to principles described herein.

FIG. 9 illustrates an exemplary method of providing multiple network services by way of a single M2M gateway device according to principles described herein.

FIG. 10 illustrates another exemplary method of providing multiple network services by way of a single M2M gateway device according to principles described herein.

FIG. 11 illustrates another exemplary method of providing multiple network services by way of a single M2M gateway device according to principles described herein.

FIG. 12 illustrates an exemplary computing device according to principles described herein.

### DETAILED DESCRIPTION OF PREFERRED EMBODIMENTS

Methods and systems for providing multiple network services by way of a single machine-to-machine (“M2M”) gateway device are described herein. As will be described below, an M2M solutions provider subsystem may 1) maintain data representative of a plurality of distinct data processing schemes associated with a plurality of network services, 2) receive a plurality of data streams from a single M2M gateway device, 3) identify a data stream included in the plurality of data streams as corresponding to a network service included in the plurality of network services, and 4) process, in response to the identification, the data stream in accordance with a data processing scheme associated with the network service.

To illustrate, an M2M solutions provider subsystem may concurrently receive first and second data streams from a single M2M gateway device. The M2M solutions provider subsystem may identify the first data stream as corresponding to a first network service (e.g., an M2M network service such as an SSD service) and the second data stream as corresponding to a second network service (e.g., another M2M network service or a non-M2M network service such as a mobile broadband service). The M2M solutions provider subsystem may then process the first and second data streams in accordance with different data processing schemes. For example, the M2M solutions provider subsystem may bill a first entity for data included in the first data stream and a second entity for data included in the second data stream, provide different quality of service levels for the first and second data streams, provide different security levels for the first and second data streams, and/or otherwise differently process the first and second data streams.

As used herein, “network services” may include any combination of M2M network services (i.e., network services that utilize M2M technology such as SSD services, pay-as-you-go (“PAYD”) insurance services, device monitoring services, etc.) and non-M2M network services (i.e., network services that traditionally do not utilize M2M technology such as mobile broadband services, mobile advertising services, voice communication services, etc.).

Numerous advantages and benefits are associated with the methods and systems described herein. For example, an M2M wireless connection (e.g., an LTE connection identified by the M2M solutions provider subsystem with a single subscription identifier such as IMSI or MSISDN) between a single M2M gateway device and an M2M solutions provider subsystem that provides a particular M2M network service by way of the M2M gateway device may be leveraged to provide other M2M network services and/or non-M2M network services by way of the M2M gateway device. This may obviate the need to provide multiple transport subscriptions and/or to install multiple M2M gateway devices (e.g., multiple wireless modules) within an automobile, building, or other premises where it is desirable to provide multiple M2M and/or non-M2M network services. This, in turn, may reduce the cost of providing network services by way of an M2M gateway device, facilitate increased use of M2M technology, and take advantage of the availability of relatively high bandwidth wireless connections (e.g., LTE connections).

To illustrate, an automobile manufacturer may install a wireless module (e.g., a wireless enabled TCU) within an automobile. The wireless module may be used initially to provide an SSD service (e.g., a service provided by OnStar) to a user of the automobile. Subsequently, the user may enroll in a PAYD insurance service in which an insurance carrier (e.g., Progressive) monitors the user's driving habits and adjusts the user's automobile insurance rates accordingly. Utilizing the methods and systems described herein, the wireless module may be leveraged to provide both of these M2M network services, thereby obviating the need for the insurance carrier to install another wireless module within the automobile in order to provide the PAYD insurance service. For example, the wireless module may be configured to concurrently transmit an M2M data stream associated with the SSD service and an M2M data stream associated with the PAYD insurance service to an M2M solutions provider subsystem, which may process the data streams differently in accordance with data processing schemes associated with each of the services (e.g., by automatically billing the SSD service provider and the PAYD insurance service provider for the data included in their respective data streams).

Continuing with this example, various non-M2M network services may also be provided by way of the wireless module installed within the automobile. For example, a mobile broadband service may be provided to a user within the automobile by way of the wireless module. Advertisement content may also be streamed to a computing device within the automobile by way of the wireless module. The M2M solutions provider subsystem may track data usage for each of these services and bill the user for data associated with the mobile broadband service and a provider of the advertisement content for data associated with the streaming of the advertisement content. Additional processing may be performed on the various data streams provided by the wireless module as will be described below.

As another example, a wireless enabled utility meter may be installed within a home and used to wirelessly transmit power consumption data associated with the home to a utility company. The wireless enabled utility meter may be leveraged to provide one or more other M2M network services (e.g., one or more appliance monitoring services) as well as one or more non-M2M network services (e.g., one or more mobile broadband services, voice communication services, etc). It will be recognized that the methods and systems described herein may be beneficial in many other settings as may serve a particular implementation.

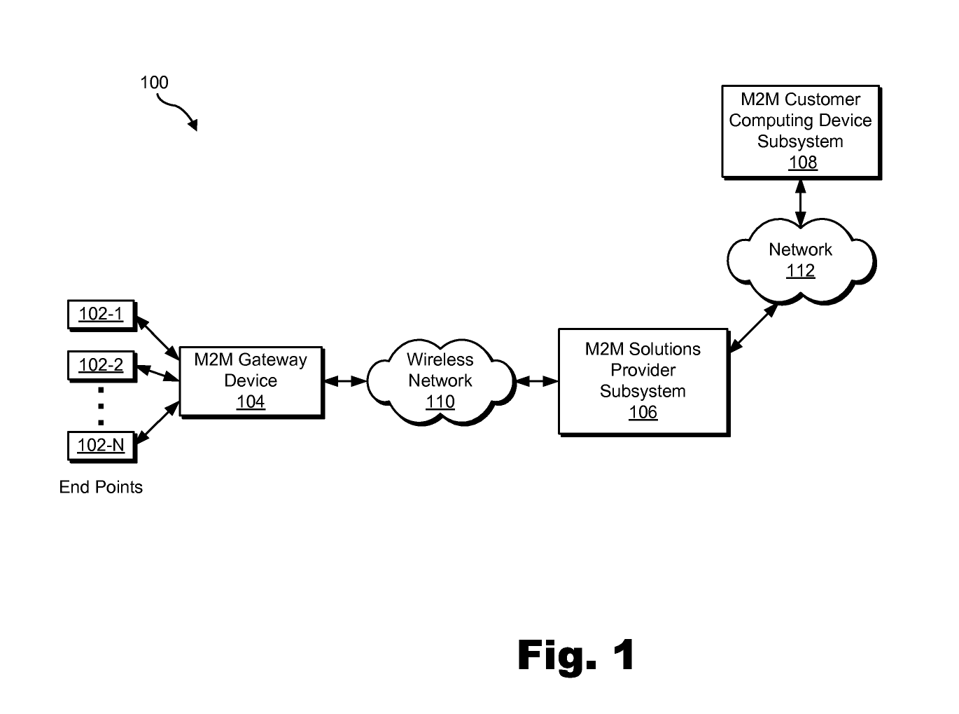

FIG. 1 illustrates an exemplary M2M system 100. As shown, system 100 may include a plurality of end points 102 (e.g., end points 102-1 through 102-N), an M2M gateway device 104, an M2M solutions provider subsystem 106, and an M2M customer computing device subsystem 108. Each of these components will now be described in detail.

End points 102 may include any devices, machines, apparatuses, computing devices, sensors, and/or other assets configured to communicate with and/or be monitored by M2M customer computing device subsystem 108 by way of M2M gateway device 104 and M2M solutions provider subsystem 106. For example, end points 102 may include parking meters, vending machines, digital billboards, utility meters, appliances, automobiles, personal computers, remotely deployed field devices, etc.

In some examples, as will be described below, one or more end points 102 may be additionally or alternatively be configured to communicate with a non-M2M content provider subsystem. End points that communicate with and/or are monitored by M2M customer computing device subsystem 108 will be referred to herein as “M2M end points” and end points that communicate with a non-M2M content provider subsystem will be referred to herein as “non-M2M end points.”

One or more end points 102 may be associated with (e.g., owned by, operated by, and/or managed by) a customer of an M2M solutions provider. Additionally or alternatively, one or more end points 102 may be associated with any other entity (e.g., an end user).

M2M gateway device 104 may include any device configured to provide an M2M communication interface for end points 102. In other words, M2M gateway device 104 may be configured to function as a communication gateway or hub for end points 102. To this end, M2M gateway device 104 may include communication hardware (e.g., a cellular modem and/or a subscriber identity module (“SIM”) card) configured to facilitate communication between end points 102 and M2M solutions provider subsystem 106 by way of a wireless network 110. M2M gateway device 104 will be described in more detail below.

In some examples, M2M gateway device 104 may be integrated into or otherwise installed within a particular end point 102. For example, M2M gateway device 104 may be seeded (i.e., installed) within a particular end point (e.g., an automobile) by an original equipment manufacturer (“OEM”). Alternatively, a particular end point 102 (e.g., a vending machine) may be retrofitted with M2M gateway device 104 after the end point has already been deployed.

End points 102 may be communicatively coupled to M2M gateway device 104 in any suitable manner. For example, one or more end points 102 may be communicatively coupled to M2M gateway device by way of one or more wireless connections (e.g., one or more WiFi, ZigBee, Z-Wave, or other types of wireless connections) and/or one or more wired connections (e.g., one or more coaxial cable connections, Ethernet connections, or other types of wired connections).

M2M customer computing device subsystem 108 may be implemented by one or more computing devices configured to communicate with one or more of end points 102 utilizing M2M technology. For example, M2M customer computing device subsystem 108 may be implemented by one or more servers located within one or more data centers operated by one or more customers of an M2M solutions provider operating M2M solutions provider subsystem 106.

In some examples, M2M customer computing device subsystem 108 may be associated with (e.g., owned by, operated by, and/or managed by) a customer of an M2M solutions provider. For example, the customer may include an entity (e.g., a business, person, etc.) that has various computing devices, machines, sensors, data centers, and/or other assets that communicate one with another by way of an M2M platform and an M2M solution provided by M2M solutions provider subsystem 106.

M2M solutions provider subsystem 106 may include and/or be implemented by one or more appropriately configured computing devices, such as one or more server devices located at one or more data centers, and may be configured to facilitate M2M communication between M2M customer computing device subsystem 108 and one or more end points 102. For example, M2M solutions provider subsystem 106 may provide a wireless network (e.g., wireless network 110) and an M2M platform upon which an M2M solution may be built for a customer associated with M2M customer computing device subsystem 108. The customer may accordingly utilize the M2M solution and underlying M2M platform in order to facilitate M2M communications between various end points 102 and M2M customer computing device subsystem 108. M2M solutions provider subsystem 106 will be described in more detail below.

As mentioned, M2M gateway device 104 may communicate with M2M solutions provider subsystem 106 by way of wireless network 110. Wireless network 110 may include one or more wireless networks, cellular networks (e.g., 3G, 4G, or LTE networks), transport networks, and/or carrier-specific networks capable of carrying data and communications signals between M2M gateway device 104 and M2M solutions provider subsystem 106.

Likewise, M2M solutions provider subsystem 106 may be configured to communicate with M2M customer computing device subsystem 108 by way of network 112. Network 112 may include one or more wireless networks, cellular networks (e.g., 3G, 4G, or LTE networks), carrier-specific networks, broadband networks, closed media networks, cable networks, satellite networks, the Internet, intranets, wide area networks, local area networks, public networks, private networks, optical fiber networks, and/or any other networks or combination of networks capable of carrying data and communications signals between M2M solutions provider subsystem 106 and M2M customer computing device subsystem 108.

While networks 110 and 112 are shown to be separate networks in FIG. 1 (e.g., network 110 may include one or more telecommunication carrier networks and network 112 may include the Internet), it will be recognized that, in some examples, networks 110 and 112 may alternatively be a single network (e.g., a single wireless network).

M2M gateway device 104, M2M solutions provider subsystem 106, and M2M customer computing device subsystem 108 may communicate using any communication technologies suitable for transporting data, including known communication devices, media, and protocols supportive of remote or local data communications. Examples of such communication technologies include, but are not limited to, data transmission media, communications devices (e.g., network devices such as routers, switches, etc.), Transmission Control Protocol (“TCP”), Internet Protocol (“IP”), Hypertext Transfer Protocol (“HTTP”), Hypertext Transfer Protocol Secure (“HTTPS”), Session Initiation Protocol (“SIP”), Ethernet, and any other suitable communications technologies, devices, media, and protocols, including any of those disclosed herein.

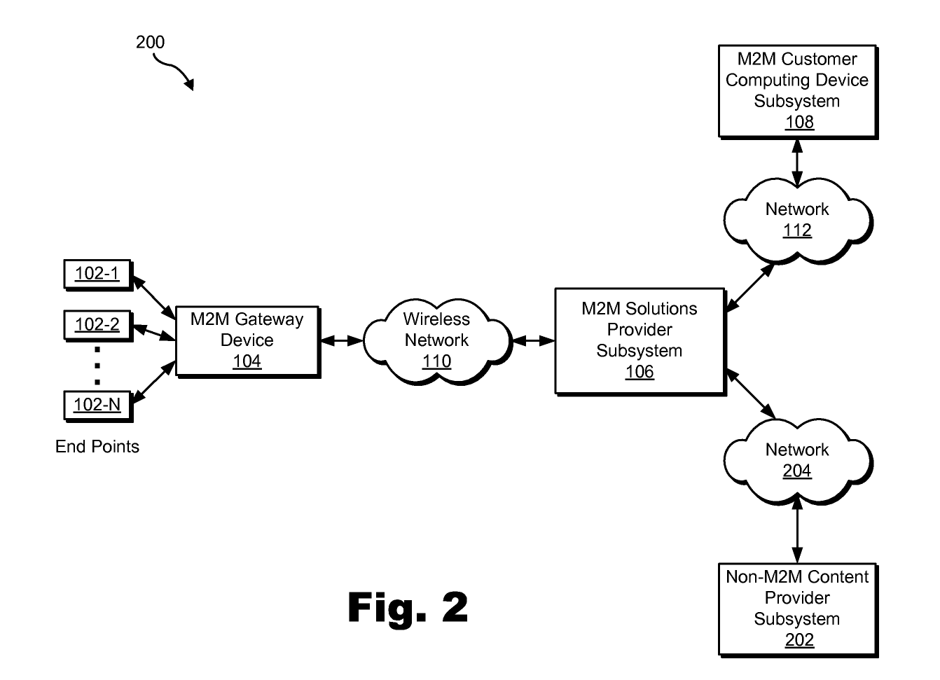

FIG. 2 illustrates an exemplary implementation 200 of M2M system 100 in which M2M solutions provider subsystem 106 is further configured to facilitate communication between one or more of end points 102 and a non-M2M content provider subsystem 202. Exemplary manners in which M2M solutions provider subsystem 106 facilitates communication between one or more end points 102 and non-M2M content provider subsystem 202 will be described below.

Non-M2M content provider subsystem 202 may be implemented by one or more computing devices (e.g., one or more servers) configured to provide non-M2M network content (e.g., Internet content, advertising content, media content, etc.) to one or more end points 102 (e.g., one or more non-M2M end points). To this end, non-M2M content provider subsystem 202 may be associated with (e.g., owned by, operated by, and/or managed by) one or more Internet content providers, advertisement content providers, and/or any other entity that provides non-M2M network content.

As shown, M2M solutions provider subsystem 106 and non-M2M content provider subsystem 202 may be configured to communicate with one another by way of network 204. Network 204 may include one or more wireless networks, cellular networks (e.g., 3G, 4G, or LTE networks), carrier-specific networks, broadband networks, closed media networks, cable networks, satellite networks, the Internet, intranets, wide area networks, local area networks, public networks, private networks, optical fiber networks, and/or any other networks or combination of networks capable of carrying data and communications signals between M2M solutions provider subsystem 106 and non-M2M content provider subsystem 202. In some embodiments, networks 110 and 204 may be implemented by a single network.

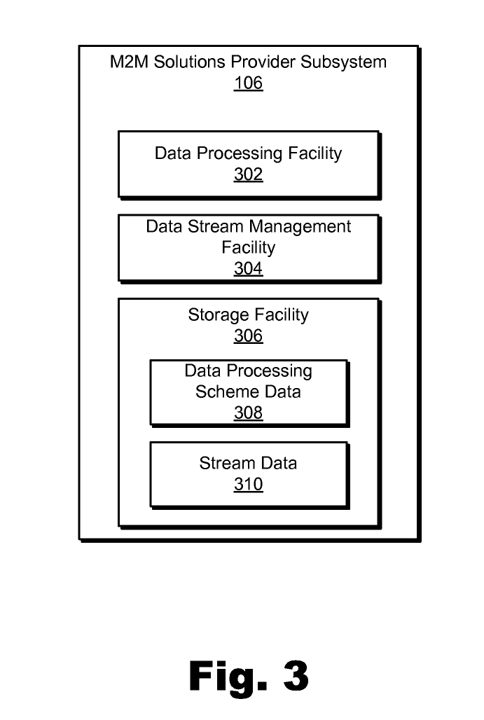

FIG. 3 illustrates various components of M2M solutions provider subsystem 106. As mentioned, M2M solutions provider subsystem 106 may be configured to facilitate communication between M2M customer computing device subsystem 108 and one or more end points 102 and between non-M2M content provider subsystem 202 and one or more end points 102. As a result, multiple network services may be provided (e.g., concurrently) by way of M2M gateway device 104.

As shown, M2M solutions provider subsystem 106 may include, without limitation, a data processing facility 302, a data stream management facility 304, and a storage facility 306 selectively and communicatively coupled to one another. It will be recognized that although facilities 302-306 are shown to be separate facilities in FIG. 3, any of facilities 302-306 may be combined into fewer facilities, such as into a single facility, or divided into more facilities as may serve a particular implementation.

Data processing facility 302 may be configured to perform one or more data processing operations on data received from M2M gateway device 104. To this end, data processing facility 302 may maintain data representative of a plurality of distinct data processing schemes associated with a plurality of network services. As will be described below, each data processing scheme may specify a particular manner in which data included in a particular data stream is to be processed by data processing facility 302 in order to provide an appropriate network service.

Data processing facility 302 may maintain data representative of the plurality of distinct data processing schemes in any suitable manner. For example, data processing facility 302 may assign a distinct service identifier to each network service and link the service identifiers within a database to the data processing schemes that are associated with the network services. To illustrate, a particular network service may be assigned a particular service identifier. Data processing facility 302 may then link the network identifier to a data processing scheme that is associated with the particular network service within a database. In this manner, as will be illustrated below, data processing facility 302 may readily identify a particular data processing scheme that is to be applied to a particular data stream received from the single M2M gateway device.

Data stream management facility 304 may be configured to perform one or more data stream management operations. For example, data stream management facility 304 may receive a plurality of data streams from a single M2M gateway device (e.g., M2M gateway device 104) and identify a data stream included in the plurality of data streams as corresponding to a particular network service included in the plurality of network services for which data processing schemes are maintained by data processing facility 302.

Data stream management facility 304 may receive the plurality of data streams in any suitable manner. For example, data stream management facility 304 may receive the plurality of data streams by way of a single wireless connection (e.g., an LTE connection) between M2M gateway device 104 and M2M solutions provider subsystem 106. The plurality of data streams may be received concurrently, at different times, or in any other suitable manner as may serve a particular implementation.

Data stream management facility 304 may identify a data stream as corresponding to a particular network service in any suitable manner. For example, data stream management facility 304 may identify an attribute associated with the data stream and determine that the attribute corresponds to a service identifier assigned to the network service. The attribute may include any suitable attribute associated with the data stream. For example, the attribute may include an access point name (“APN”) associated with the data stream, a destination IP address associated with the data stream, a phone number associated with the data stream, a transmission protocol associated with the data stream, and/or an open standard identifier associated with the data stream. The attribute may be identified by analyzing data (e.g., header information) included within the data stream or any other suitable manner as may serve a particular implementation.

Once a data stream has been identified by data stream management facility 304 as corresponding to a particular network service, data processing facility 302 may process the data stream in accordance with a data processing scheme associated with the network service. For example, the data processing scheme may specify a particular entity responsible for payment for the network service, a quality of service level associated with the network service, and/or a security level associated with the network service. Hence, data processing facility 302 may process the data stream by billing the responsible entity for data included in the data stream, providing the quality of service level specified by the data processing scheme for the data stream, and/or providing the security level specified by the data processing scheme for the data stream. Examples of this will be provided in more detail below.

Data processing facility 302 may be further configured to route the data stream to an appropriate destination. For example, data processing facility 302 may identify a destination address associated with (e.g., included within) the data stream and route the data stream to a destination (e.g., M2M customer computing device subsystem 108 or non-M2M content provider subsystem 202) that corresponds to the destination address.

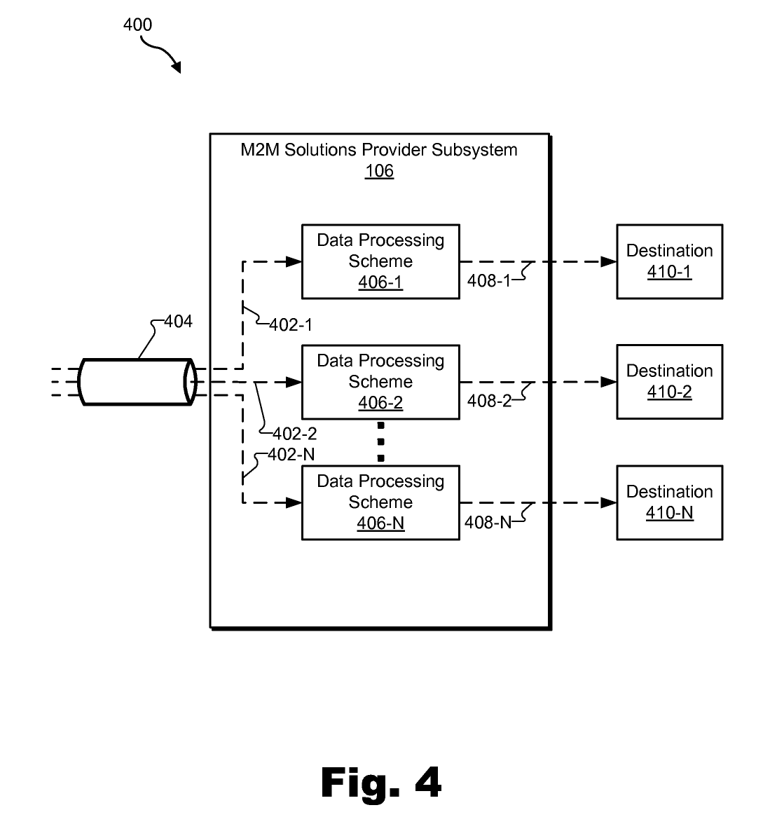

To illustrate, FIG. 4 shows an exemplary configuration 400 in which a plurality of data streams 402 (e.g., data streams 402-1 through 402-N) are received by M2M solutions provider subsystem 106 from M2M gateway device 104. As shown, data streams 402 may be transmitted by M2M gateway device 104 by way of a single wireless connection 404 (e.g., in the form of a transport stream identified by a single network identifier). As described above, M2M solutions provider subsystem 106 may process each data stream 402 in accordance with a distinct data processing scheme 406 (e.g., data processing scheme 406-1 may be applied to data stream 402-1, data processing scheme 406-2 may be applied to data stream 402-2, and data processing scheme 406-N may be applied to data stream 402-N). The processed data streams 408 (e.g., data streams 408-1 through 408-N) may then be routed to different destinations 410 (e.g., destinations 410-1 through 410-N).

It will be recognized that data processing facility 302 may similarly process data streams intended for end points 102 and provided by M2M customer computing subsystem 108 and non-M2M content provider subsystem 202. To illustrate, with reference again to FIG. 2, end point 102-1 may provide a data stream associated with a particular service to M2M gateway device 104, which may in turn transmit the data stream to M2M solutions provider subsystem 106. M2M solutions provider subsystem 106 (i.e., data processing facility 302) may process the data stream in accordance with a particular data processing scheme and route the processed data stream to a destination computing device that provides the network service (e.g., a computing device that implements M2M customer computing device subsystem 108 or non-M2M content provider subsystem 202). M2M solutions provider subsystem 106 may subsequently receive an additional data stream associated with the network service from the destination computing device that is intended for end point 102-1 and process the additional data stream in accordance with the same data processing scheme.

Returning to FIG. 3, storage facility 306 may be configured to store data processing scheme data 308 representative of data processing schemes maintained by data processing facility 302 and stream data 310 representative of or otherwise associated with data streams received from M2M gateway device 104. Storage facility 306 may maintain additional or alternative data as may serve a particular implementation.

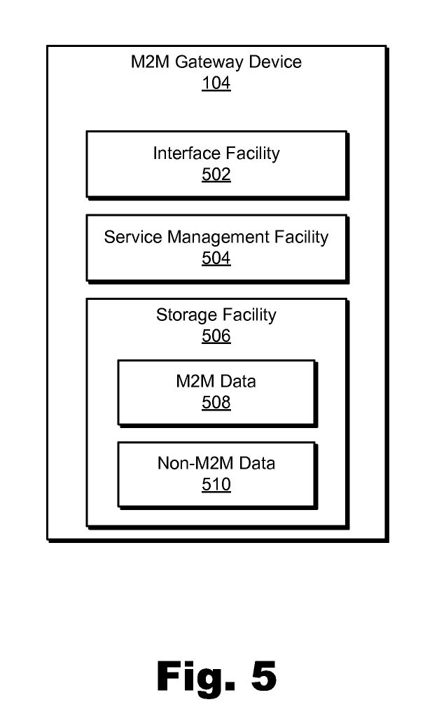

FIG. 5 illustrates various components of M2M gateway device 104. As shown, M2M gateway device 104 may include, without limitation, an interface facility 502, a service management facility 504, and a storage facility 506 selectively and communicatively coupled to one another. It will be recognized that although facilities 502-506 are shown to be separate facilities in FIG. 5, any of facilities 502-506 may be combined into fewer facilities, such as into a single facility, or divided into more facilities as may serve a particular implementation.

Interface facility 502 may be configured to provide an interface between M2M gateway device 104 and end points 102 as well as between M2M gateway device 104 and M2M solutions provider subsystem 106. For example, interface facility 502 may establish a wireless connection with M2M solutions provider subsystem 106 to provide an M2M network service to an M2M end point (e.g., end point 102-1) communicatively coupled to M2M gateway device 104. Interface facility 502 may subsequently receive M2M data (i.e., data intended for M2M customer computing device subsystem 108) from the M2M end point and transmit the M2M data to the M2M solutions provider subsystem 106 by way of the wireless connection.

Service management facility 504 may be configured to perform one or more network service management operations. For example, service management facility 504 may leverage the wireless connection established by interface facility 502 to provide a non-M2M network service by way of the wireless connection to a non-M2M end point (e.g., end point 102-2) communicatively coupled to M2M gateway device 104. This may be performed in any suitable manner. For example, service management facility 504 may direct interface facility 502 to receive non-M2M data (i.e., data intended for non-M2M content provider subsystem 202) from the non-M2M end point and transmit the non-M2M data to M2M solutions provider subsystem 106 by way of the wireless connection.

In some examples, the M2M data and the non-M2M data are transmitted concurrently (i.e., during periods of time that at least partially overlap) to M2M solutions provider subsystem 106. In other examples, the M2M data and the non-M2M data are transmitted during different periods of time that do not overlap.

M2M solutions provider subsystem 106 may process the M2M data and the non-M2M data in accordance with different data processing schemes and route the processed M2M data to M2M customer computing device subsystem 108 and the processed non-M2M data to non-M2M content provider subsystem 202.

Storage facility 506 may be configured to store M2M data 508 provided by or otherwise associated with one or more M2M end points and non-M2M data 510 provide by or otherwise associated with one or more non-M2M end points. Storage facility 506 may maintain additional or alternative data as may serve a particular implementation.

Various examples of providing multiple network services by way of a single M2M gateway device will now be described. It will be recognized that the examples provided herein are merely exemplary of the many different ways in which multiple network services may be provided by way of a single M2M gateway device.

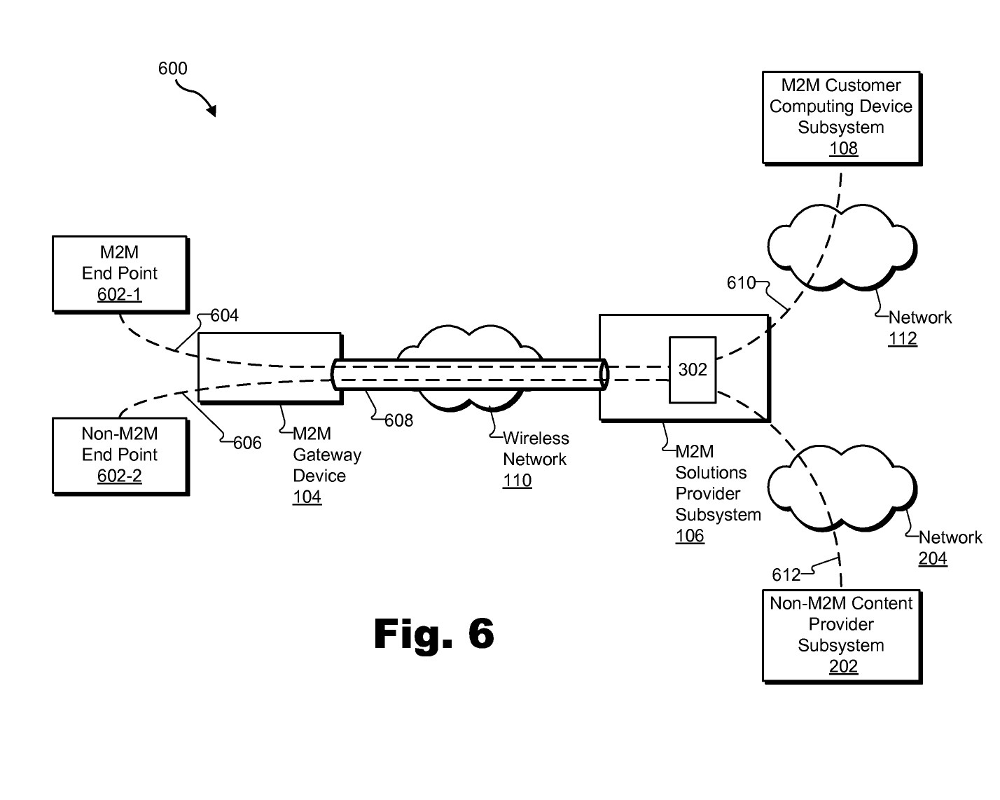

FIG. 6 shows an exemplary implementation 600 of M2M system 100 in which an M2M end point 602-1 and a non-M2M end point 602-2 are communicatively coupled to M2M gateway device 104. As shown, M2M end point 602-1 may transmit an M2M data stream 604 (i.e., a data stream that includes M2M data and that is intended for M2M customer computing device subsystem 108) to M2M gateway device 104. Likewise, non-M2M end point 602-2 may transmit a non-M2M data stream 606 (i.e., a data stream that includes non-M2M data and that is intended for non-M2M content provider subsystem 202) to M2M gateway device 104. In some examples, M2M data stream 604 and non-M2M data stream 606 are transmitted concurrently to M2M gateway device 104.

As shown, M2M gateway device 104 may route both M2M data stream 604 and non-M2M data stream 606 through wireless network 110 to M2M solutions provider subsystem 106 by way of a single wireless connection 608 (e.g., in the form of a transport stream). M2M solutions provider subsystem 106 may receive (e.g., concurrently) M2M data stream 604 and non-M2M data stream 606, identify M2M data stream 604 as corresponding to an M2M network service, and identify non-M2M data stream 606 as corresponding to a non-M2M network service. M2M solutions provider subsystem 106 (i.e., data processing facility 302) may then process M2M data stream 604 in accordance with a data processing scheme that corresponds to the M2M network service and non-M2M data stream 606 in accordance with a data processing scheme that corresponds to the non-M2M network service.

For example, as shown in FIG. 6, M2M solutions provider subsystem 106 may route the processed M2M data stream (i.e., data stream 610) to M2M customer computing device subsystem 108 and the processed non-M2M data stream (i.e., data stream 612) to non-M2M content provider subsystem 202. M2M solutions provider subsystem 106 may be further configured to bill a first entity associated with the M2M network service for data associated with the M2M network service that is transmitted back and forth between M2M end point 602-1 and M2M customer computing device subsystem 108 (e.g., for data included in data streams 604 and 610) and a second entity associated with the non-M2M network service for data associated with the non-M2M network service that is transmitted back and forth between non-M2M end point 602-2 and non-M2M content provider subsystem 202 (e.g., for data included in data streams 606 and 612), provide different quality of service and/or security levels for M2M data stream 604 and non-M2M data stream 606, and/or otherwise process data streams 604 and 606 as may serve particular implementation.

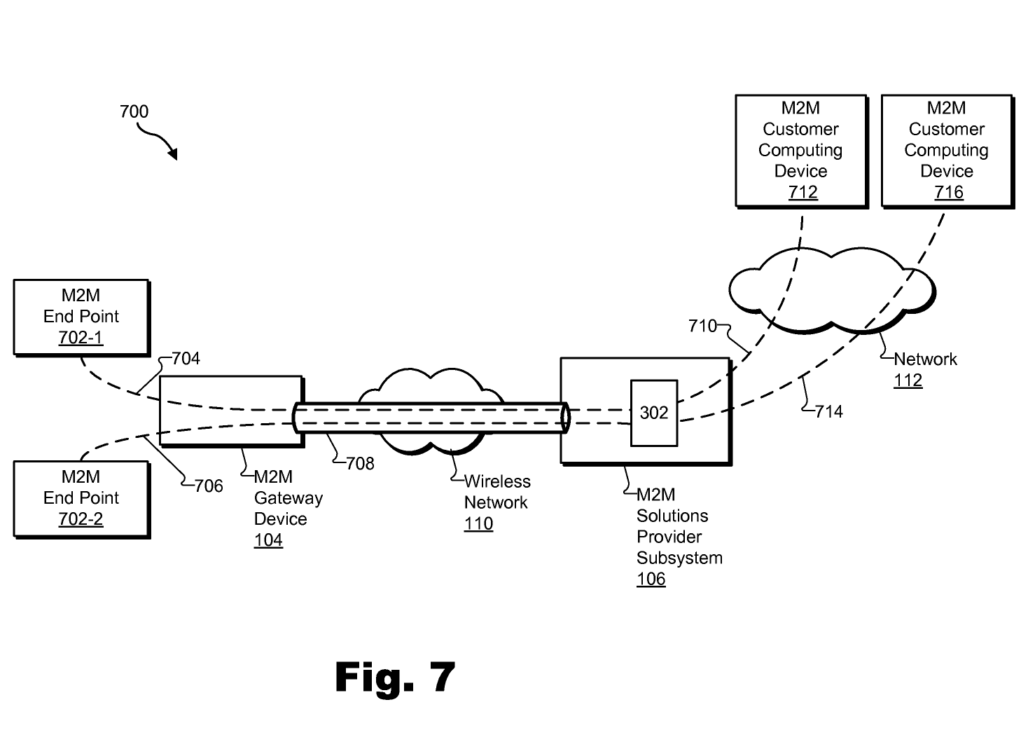

While FIG. 6 shows that an M2M network service and a non-M2M network service are provided by way of M2M gateway device 104, it will be recognized that multiple M2M network services (to the exclusion of non-M2M network services in some examples) may also be provided by way of M2M gateway device 104 in a similar manner. For example, FIG. 7 shows an exemplary implementation 700 of M2M system 100 in which first and second M2M end points 702-1 and 702-2 (collectively “M2M end points 702”) are communicatively coupled to M2M gateway device 104. As shown, M2M end point 702-1 and M2M end point 702-2 may transmit M2M data streams 704 and 706, respectively, to M2M gateway device 104.

M2M gateway device 104 may route both M2M data streams 704 and 706 through wireless network 110 to M2M solutions provider subsystem 106 by way of a single wireless connection 708 (e.g., in the form of a transport stream). M2M solutions provider subsystem 106 may receive (e.g., concurrently) M2M data streams 704 and 706, identify M2M data stream 704 as corresponding to a first M2M network service, and identify M2M data stream 706 as corresponding to a second M2M network service. M2M solutions provider subsystem 106 (i.e., data processing facility 302) may then process M2M data stream 704 in accordance with a data processing scheme that corresponds to the first M2M network service and M2M data stream 706 in accordance with a data processing scheme that corresponds to the second M2M network service.

For example, as shown in FIG. 7, M2M solutions provider subsystem 106 may route the processed M2M data stream 704 (i.e., data stream 710) to a first M2M customer computing device 712 configured to provide the first M2M network service. Likewise, M2M solutions provider subsystem 106 may route the processed M2M data stream 706 (i.e., data stream 714) to a second M2M customer computing device 716 configured to provide the second M2M network service. M2M solutions provider subsystem 106 may be further configured to bill a first entity associated with the first M2M network service for data associated with the first M2M network service that is transmitted back and forth between M2M end point 702-1 and M2M customer computing device 712 (e.g., for data included in data streams 704 and 710) and a second entity associated with the second M2M network service for data associated with the second M2M network service that is transmitted back and forth between M2M end point 702-2 and M2M customer computing device 716 (e.g., for data included in data streams 706 and 714), provide different quality of service and/or security levels for M2M data streams 704 and 706, and/or otherwise process M2M data streams 704 and 706 as may serve particular implementation.

As mentioned, M2M solutions provider subsystem 106 (i.e., data processing facility 302) may maintain data representative of a plurality of distinct data processing schemes in any suitable manner. For example, M2M solutions provider subsystem 106 may assign a distinct service identifier to each of a plurality of network services and link the service identifiers within a database to the data processing schemes that are associated with the network services.

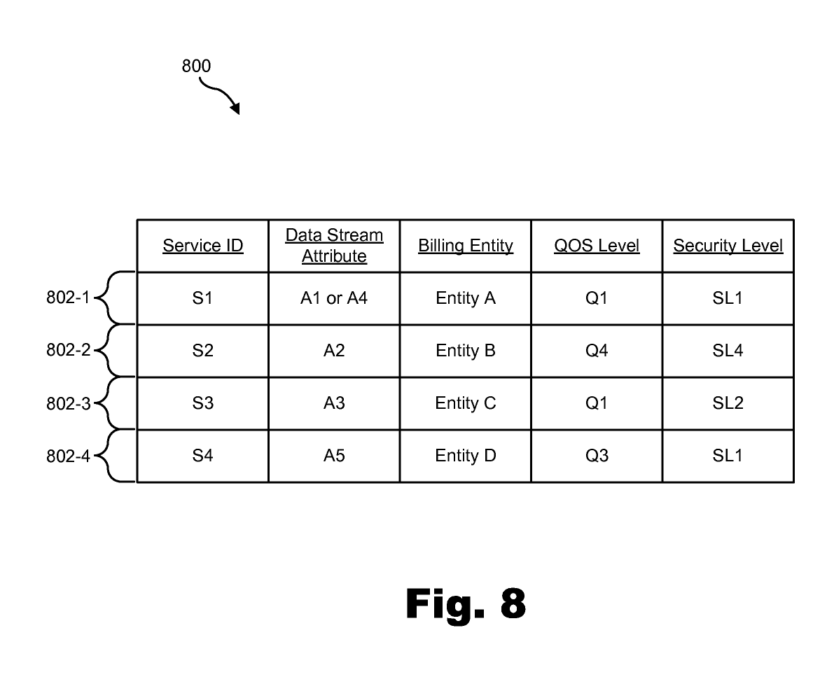

To illustrate, FIG. 8 shows an exemplary look up table 800 that may be maintained within a database by M2M solutions provider subsystem 106. As shown, look up table 800 may include a plurality of entries 802 (e.g., entries 802-1 through 802-4) each corresponding to a particular network service. As shown, each network service has been assigned a service identifier (e.g., service identifiers S1-S4). Each service identifier is linked to one or more data stream attributes and one or more fields that constitute a particular data processing scheme. To illustrate, look up table 800 shows that service identifier S1 is linked to data stream attributes “A1” and “A4” as well as to a data processing scheme that specifies a billing entity of “Entity A,” a quality of service level of “Q1,” and a security level of “SL1”. Likewise, service identifiers S2 through S4 are linked to the various data stream attributes and data processing schemes shown in entries 802-2 through 802-4.

For purposes of this example, a data stream may have one of five different data stream attributes labeled “A1” through “A5.” As described above, each data stream attribute may specify an access point name (“APN”) associated with the data stream, a destination IP addresses associated with the data stream, a phone number associated with the data stream, a transmission protocol associated with the data stream, an open standard identifier associated with the data stream, and/or any other attribute of the data stream as may serve a particular implementation.

Likewise, for purposes of this example, a particular data processing scheme may specify one of four different billing entities labeled “Entity A” through “Entity D,” one of four different quality of service levels labeled “Q1” through “Q4,” and one of four different security levels labeled “SL1” through “SL4.” Each quality of service level specifies a particular set of quality-related attributes that are to be associated with the data stream (e.g., a bandwidth level, a signal-to-noise ratio level, a bit rate, a latency, etc.). Each security level specifies a particular set of security-related attributes that are to be associated with the data stream (e.g., an encryption scheme used to encrypt data within the data stream, a domain-specific security setting to be used for the data stream, etc.).

Using look up table 800, M2M solutions provider subsystem 106 may readily identify a particular data processing scheme that is to be applied to a particular data stream received from M2M gateway device 104. To illustrate, M2M solutions provider subsystem 106 may receive a data stream from M2M gateway device 104 and determine that the data stream has a data stream attribute of “A4” (e.g., by analyzing header information included in the data stream). M2M solutions provider subsystem 106 may then use look up table 800 to determine that the data stream attribute of “A4” is linked to a service identifier of “S1.” M2M solutions provider subsystem 106 may accordingly process the data stream in accordance with the data processing scheme specified in entry 802-1 by billing the entity named “Entity A” for data included in the data stream, providing a quality of service level of “Q1” for the data stream, and providing a security level of “SL1” for the data stream.

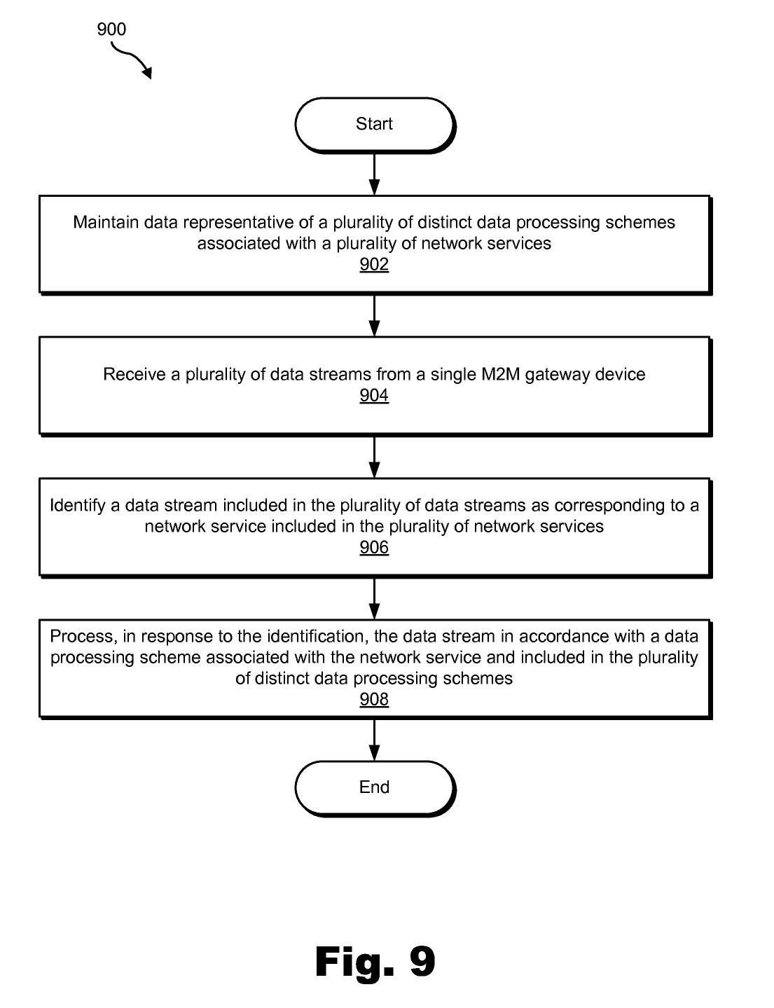

FIG. 9 illustrates an exemplary method 900 of providing multiple network services by way of a single M2M gateway device. While FIG. 9 illustrates exemplary steps according to one embodiment, other embodiments may omit, add to, reorder, and/or modify any of the steps shown in FIG. 9. One or more of the steps shown in FIG. 9 may be performed by M2M solutions provider subsystem 106 and/or any implementation thereof.

In step 902, an M2M solutions provider subsystem maintains data representative of a plurality of distinct data processing schemes associated with a plurality of network services. Step 902 may be performed in any of the ways described herein.

In step 904, the M2M solutions provider subsystem receives a plurality of data streams from a single M2M gateway device. Step 904 may be performed in any of the ways described herein.

In step 906, the M2M solutions provider subsystem identifies a data stream included in the plurality of data streams as corresponding to a network service included in the plurality of network services. Step 906 may be performed in any of the ways described herein.

In step 908, the M2M solutions provider subsystem processes, in response to the identification, the data stream in accordance with a data processing scheme associated with the network service and included in the plurality of distinct data processing schemes. Step 908 may be performed in any of the ways described herein.

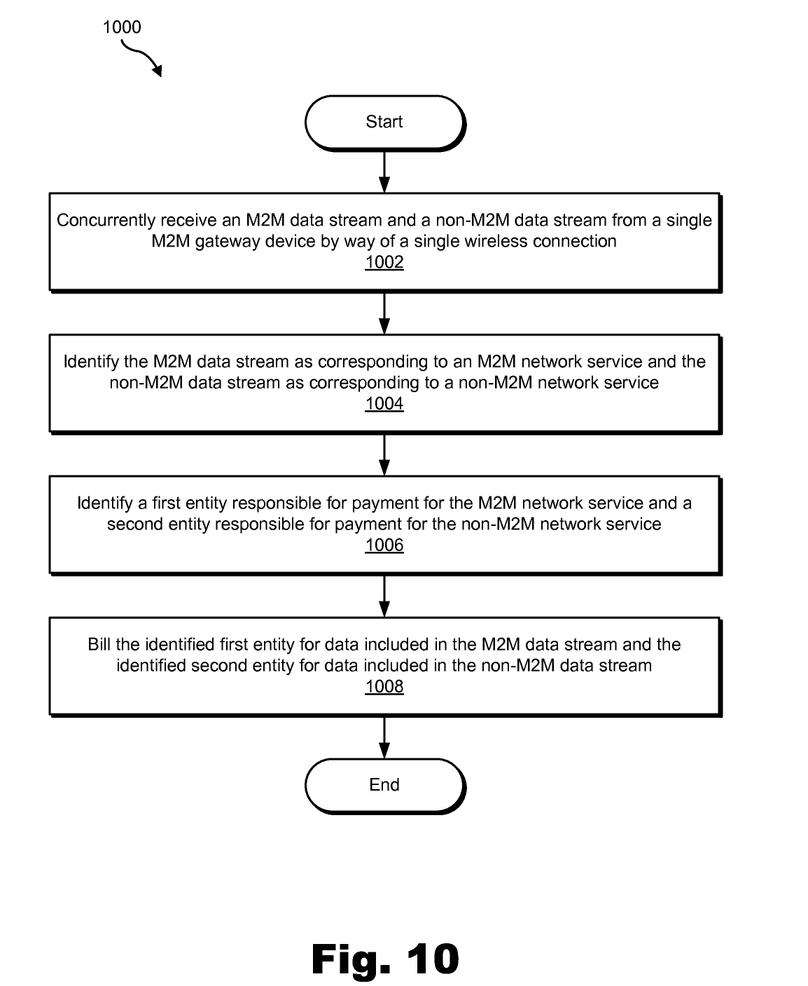

FIG. 10 illustrates another exemplary method 1000 of providing multiple network services by way of a single M2M gateway device. While FIG. 10 illustrates exemplary steps according to one embodiment, other embodiments may omit, add to, reorder, and/or modify any of the steps shown in FIG. 10. One or more of the steps shown in FIG. 10 may be performed by M2M solutions provider subsystem 106 and/or any implementation thereof.

In step 1002, an M2M solutions provider subsystem concurrently receives an M2M data stream and a non-M2M data stream from a single M2M gateway device by way of a single wireless connection. Step 1002 may be performed in any of the ways described herein.

In step 1004, the M2M solutions provider subsystem identifies the M2M data stream as corresponding to an M2M network service and the non-M2M data stream as corresponding to a non-M2M network service. Step 1004 may be performed in any of the ways described herein.

In step 1006, the M2M solutions provider subsystem identifies a first entity responsible for payment for the M2M network service and a second entity responsible for payment for the non-M2M network service. Step 1006 may be performed in any of the ways described herein.

In step 1008, the M2M solutions provider subsystem bills the identified first entity for data included in the M2M data stream and the identified second entity for data included in the non-M2M data stream. Step 1008 may be performed in any of the ways described herein.

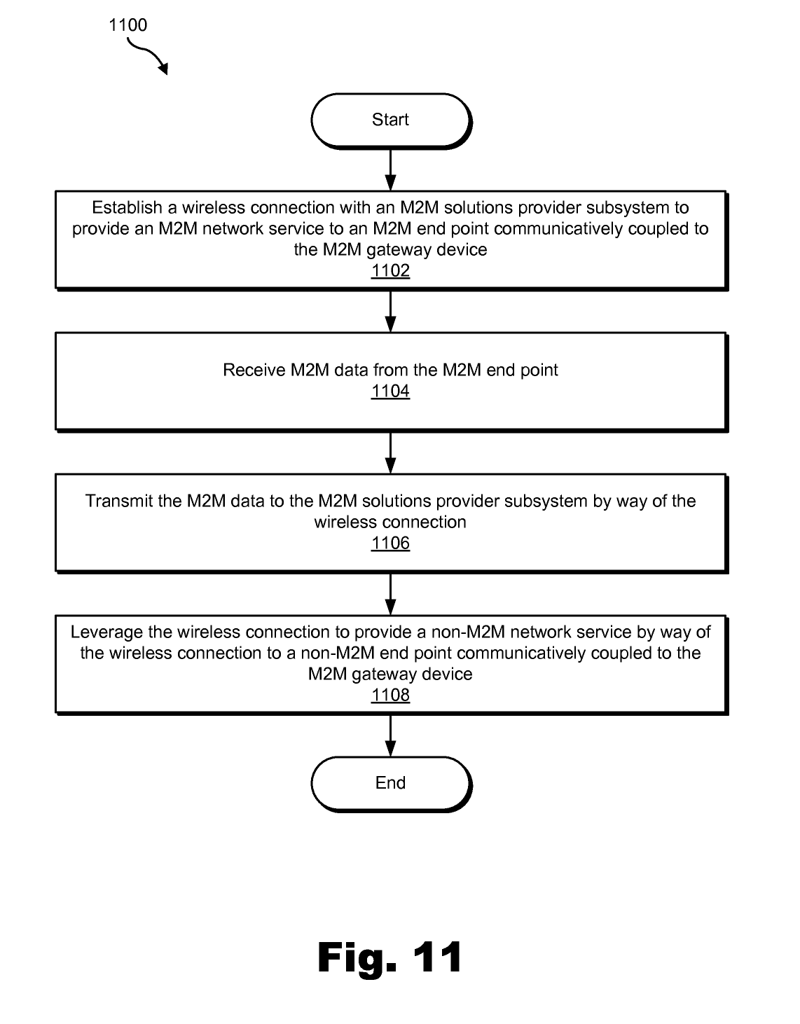

FIG. 11 illustrates another exemplary method 1100 of providing multiple network services by way of a single M2M gateway device. While FIG. 11 illustrates exemplary steps according to one embodiment, other embodiments may omit, add to, reorder, and/or modify any of the steps shown in FIG. 11. One or more of the steps shown in FIG. 11 may be performed by M2M gateway device 104 and/or any implementation thereof.

In step 1102, an M2M gateway device establishes a wireless connection with an M2M solutions provider subsystem to provide an M2M network service to an M2M end point communicatively coupled to the M2M gateway device. Step 1102 may be performed in any of the ways described herein.

In step 1104, the M2M gateway device receives M2M data from the M2M end point. Step 1104 may be performed in any of the ways described herein.

In step 1106, the M2M gateway device transmits the M2M data to the M2M solutions provider subsystem by way of the wireless connection. Step 1106 may be performed in any of the ways described herein.

In step 1108, the M2M gateway device leverages the wireless connection to provide a non-M2M network service by way of the wireless connection to a non-M2M end point communicatively coupled to the M2M gateway device. Step 1108 may be performed in any of the ways described herein.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

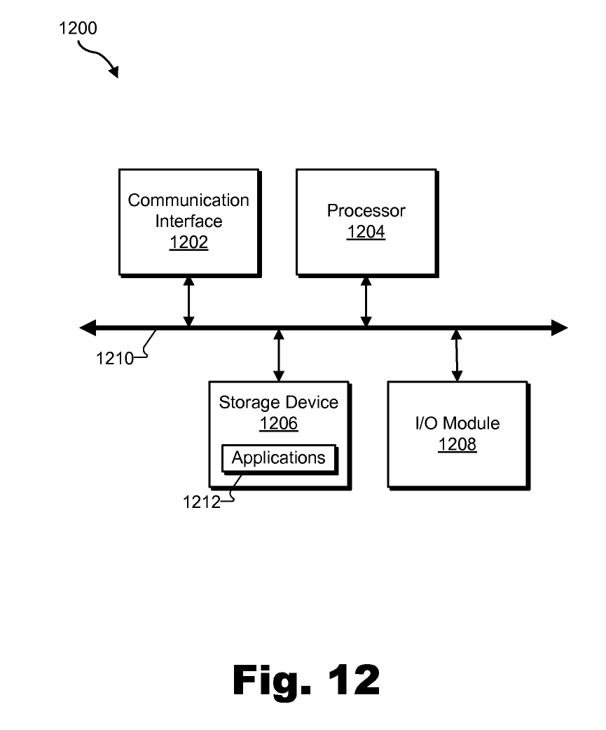

FIG. 12 illustrates an exemplary computing device 1200 that may be configured to perform one or more of the processes described herein. As shown in FIG. 12, computing device 1200 may include a communication interface 1202, a processor 1204, a storage device 1206, and an input/output (“I/O”) module 1208 communicatively connected via a communication infrastructure 1210. While an exemplary computing device 1200 is shown in FIG. 12, the components illustrated in FIG. 12 are not intended to be limiting. Additional or alternative components may be used in other embodiments. Components of computing device 1200 shown in FIG. 12 will now be described in additional detail.

Communication interface 1202 may be configured to communicate with one or more computing devices. Examples of communication interface 1202 include, without limitation, a wired network interface (such as a network interface card), a wireless network interface (such as a wireless network interface card), a modem, an audio/video connection, and any other suitable interface.

Processor 1204 generally represents any type or form of processing unit capable of processing data or interpreting, executing, and/or directing execution of one or more of the instructions, processes, and/or operations described herein. Processor 1204 may direct execution of operations in accordance with one or more applications 1212 or other computer-executable instructions such as may be stored in storage device 1206 or another computer-readable medium.

Storage device 1206 may include one or more data storage media, devices, or configurations and may employ any type, form, and combination of data storage media and/or device. For example, storage device 1206 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1206. For example, data representative of one or more executable applications 1212 configured to direct processor 1204 to perform any of the operations described herein may be stored within storage device 1206. In some examples, data may be arranged in one or more databases residing within storage device 1206.

I/O module 1208 may be configured to receive user input and provide user output and may include any hardware, firmware, software, or combination thereof supportive of input and output capabilities. For example, I/O module 1208 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1208 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1208 is configured to provide graphical data to a display for presentation to a user. The graphical data may be representative of one or more graphical user interfaces and/or any other graphical content as may serve a particular implementation.

In some examples, any of the systems, subsystems, and/or facilities described herein may be implemented by or within one or more components of computing device 1200. For example, one or more applications 1212 residing within storage device 1206 may be configured to direct processor 1204 to perform one or more processes or functions associated with data processing facility 302, data stream management facility 304, interface facility 502, and/or service management facility 504. Likewise, storage facility 306 and/or storage facility 506 may be implemented by or within storage device 1206.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
maintaining, by a machine-to-machine (“M2M”) solutions provider subsystem, data representative of a plurality of distinct data processing schemes associated with a plurality of network services;
receiving, by the M2M solutions provider subsystem, a plurality of data streams from a single M2M gateway device;
identifying, by the M2M solutions provider subsystem, a data stream included in the plurality of data streams as corresponding to a network service included in the plurality of network services; and
processing, by the M2M solutions provider subsystem in response to the identifying, the data stream in accordance with a data processing scheme associated with the network service and included in the plurality of distinct data processing schemes.

2. The method of claim 1, further comprising:
identifying, by the M2M solutions provider subsystem, an additional data stream included in the plurality of data streams as corresponding to an additional network service included in the plurality of network services; and
processing, by the M2M solutions provider subsystem in response to the identifying of the additional data stream as corresponding to the additional network service, the additional data stream in accordance with an additional data processing scheme associated with the additional network service and included in the plurality of distinct data processing schemes.

3. The method of claim 2, wherein:
the processing of the data stream in accordance with the data processing scheme associated with the network service comprises billing a first entity associated with the network service for data included in the data stream;
the processing of the additional data stream in accordance with the additional data processing scheme associated with the additional network service comprises billing a second entity associated with the additional network service for data included in the additional data stream; and
the second entity is different than the first entity.

4. The method of claim 2, wherein:
the processing of the data stream in accordance with the data processing scheme associated with the network service comprises providing a first quality of service level for the data stream;
the processing of the additional data stream in accordance with the additional data processing scheme associated with the additional network service comprises providing a second quality of service level for the additional data stream; and
the second quality of service level is different than the first quality of service level.

5. The method of claim 2, wherein:
the processing of the data stream in accordance with the data processing scheme associated with the network service comprises providing a first security level for the data stream;
the processing of the additional data stream in accordance with the additional data processing scheme associated with the additional network service comprises providing a second security level for the additional data stream; and
the second security level is different than the first security level.

6. The method of claim 2, wherein the network service is an M2M network service and the additional network service is a non-M2M network service.

7. The method of claim 1, wherein the processing of the data stream in accordance with the data processing scheme associated with the network service comprises:
identifying an entity responsible for payment for the network service; and
billing the identified entity for data included in the data stream.

8. The method of claim 1, wherein the processing of the data stream in accordance with the data processing scheme associated with the network service comprises:
identifying a quality of service level associated with the network service; and
providing the identified quality of service level for the data stream.

9. The method of claim 1, wherein the processing of the data stream in accordance with the data processing scheme associated with the network service comprises:
identifying a security level associated with the network service; and
providing the identified security level for the data stream.

10. The method of claim 1, wherein the maintaining of the data representative of the plurality of distinct data processing schemes comprises:
assigning a distinct service identifier to the network service; and
linking the distinct service identifier to the data processing scheme associated with the network service within a database.

11. The method of claim 10, wherein the identifying of the data stream as corresponding to the network service comprises:
identifying an attribute associated with the data stream; and
determining that the attribute corresponds to the distinct service identifier assigned to the network service.

12. The method of claim 11, wherein the attribute comprises at least one of an access point name (“APN”) associated with the data stream, a destination Internet protocol (“IP”) address associated with the data stream, a phone number associated with the data stream, a transmission protocol associated with the data stream, and an open standard identifier associated with the data stream.

13. The method of claim 1, wherein the receiving of the plurality of data streams from the single M2M gateway device comprises concurrently receiving the plurality of data streams from the single M2M gateway device by way of a single wireless connection.

14. The method of claim 13, wherein the single wireless connection is a Long Term Evolution (“LTE”) connection.

15. The method of claim 1, wherein the data stream is provided by an end point communicatively coupled to the M2M gateway device, and wherein the method further comprises:
receiving, by the M2M solutions provider subsystem, an additional data stream intended for the end point from a computing device that provides the network service; and
processing, by the M2M solutions provider subsystem, the additional data stream in accordance with the data processing scheme.

16. The method of claim 1, embodied as computer-executable instructions on at least one non-transitory computer-readable medium.

17. A method comprising:
concurrently receiving, by a machine-to-machine (“M2M”) solutions provider subsystem, an M2M data stream and a non-M2M data stream from a single M2M gateway device by way of a single wireless connection;
identifying, by the M2M solutions provider subsystem, the M2M data stream as corresponding to an M2M network service and the non-M2M data stream as corresponding to a non-M2M network service;
identifying, by the M2M solutions provider subsystem, a first entity responsible for payment for the M2M network service and a second entity responsible for payment for the non-M2M network service; and
billing, by the M2M solutions provider subsystem, the identified first entity for data included in the M2M data stream and the identified second entity for data included in the non-M2M data stream.

18. The method of claim 17, embodied as computer-executable instructions on at least one non-transitory computer-readable medium.

19. A method comprising:
establishing, by a machine-to-machine (“M2M”) gateway device, a wireless connection with an M2M solutions provider subsystem to provide an M2M network service to an M2M end point communicatively coupled to the M2M gateway device;
receiving, by the M2M gateway device, M2M data from the M2M end point;
transmitting, by the M2M gateway device, the M2M data to the M2M solutions provider subsystem by way of the wireless connection; and
leveraging, by the M2M gateway device, the wireless connection to provide a non-M2M network service by way of the wireless connection to a non-M2M end point communicatively coupled to the M2M gateway device.

20. The method of claim 19, wherein the leveraging of the wireless connection to provide the non-M2M network service by way of the wireless connection to the non-M2M end point comprises:
receiving non-M2M data from the non-M2M end point; and
transmitting the non-M2M data to the M2M solutions provider subsystem by way of the wireless connection.

21. The method of claim 20, wherein the transmitting of the non-M2M data and the transmitting of the M2M data are performed concurrently.

22. The method of claim 20, further comprising:
routing, by the M2M solutions provider subsystem, the M2M data to an M2M customer computing device subsystem; and
routing, by the M2M solutions provider subsystem, the non-M2M data to a non-M2M content provider subsystem.

23. The method of claim 20, embodied as computer-executable instructions on at least one non-transitory computer-readable medium.

24. A system comprising:
a data processing facility configured to maintain data representative of a plurality of distinct data processing schemes associated with a plurality of network services; and
a data stream management facility communicatively coupled to the data processing facility and configured to
receive a plurality of data streams from a single M2M gateway device, and
identify a data stream included in the plurality of data streams as corresponding to a network service included in the plurality of network services;
wherein the data processing facility is further configured to process, in response to the identification, the data stream in accordance with a data processing scheme associated with the network service and included in the plurality of distinct data processing schemes.
